(19) United States
(12) Patent Application Publication
(10) Pub. No.: US 2019/0134676 A1
(43) Pub. Date: May 9, 2019

(54) PORTABLE AND COMPACTABLE POWER WASHER

(71) Applicants: Douglas Richard Krentz, Long Valley, NJ (US); Scott Steven Krentz, Long Valley, NJ (US)

(72) Inventors: Douglas Richard Krentz, Long Valley, NJ (US); Scott Steven Krentz, Long Valley, NJ (US)

(21) Appl. No.: 16/118,858

(22) Filed: Aug. 31, 2018

Related U.S. Application Data
(60) Provisional application No. 62/581,398, filed on Nov. 3, 2017.

(51) Int. Cl. B08B 3/02; B05B 1/30; B05B 15/60

(52) U.S. Cl. CPC B08B 3/026; B05B 15/60; B05B 1/30

(57) ABSTRACT

A portable power washer. The portable power washer includes a housing. The housing is made of a flexible material and includes a base, a sidewall, an opening, and a lid openably and closably coupled the sidewall and covering the opening. A hose coupler fluidly connects an inside of the housing with an outside of the housing. A pump is operable to pump a liquid from the inside of the housing and through the hose coupler.

### CROSS-REFERENCE TO RELATED APPLICATION

This application claims the benefit of priority of U.S. provisional application No. 62/581,398, filed Nov. 3, 2017, the contents of which are herein incorporated by reference.

### BACKGROUND OF THE INVENTION

The present invention relates to power washers and, more particularly, to a portable and compactable power washer.

Power washing is the use of high-pressure water spray to remove loose paint, mold, grime, dust, mud, chewing gun, and dirt from surfaces and objects such as buildings, vehicles and concrete surfaces. Current power washers have a hard exterior and therefore are not very compactable. Further, current power washers take up a lot of space, easily tip over, and are heavy.

As can be seen, there is a need for an improved power washer that is light weight and compactable for storage.

### SUMMARY OF THE INVENTION

In one aspect of the present invention, a portable power washer comprises: a housing made of a flexible material and comprising a base, a sidewall, an opening, and a lid openably and closably coupled the sidewall and covering the opening; a hose coupler fluidly connecting an inside of the housing with an outside of the housing; and a pump operable to pump a liquid from the inside of the housing and through the hose coupler.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a front perspective view of an embodiment of the present invention illustrating a water bag;

FIG. 3 is an exploded view of an embodiment of the present invention;

FIG. 4 is a rear perspective view of an embodiment of the present invention;

FIG. 5 is a rear perspective view of an embodiment of a support of the present invention; and

FIG. 6 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention is a portable power washer that may be used to clean, kids, pets, and gear when the user does not have access to a running water source such as a hose or a sink. The present invention allows a user to rinse or clean anything off before placing gear, pets or kids covered with sand back in your vehicle and also provides additional remote uses by using the internal components like the battery to charge or power other devices via an internal or external power connector.

The present invention holds its own water and may carry various amounts, such as one gallon up to four gallons or more. The present invention includes a spraying device and hose and sprayer assembly connected to the spray pump located inside the device. The present invention is made so that it can be packed or compressed when it is empty for better storage. The device can also help reduce the amount of water and power needed to clean things. Because the device is a pressure sprayer, it also uses low voltage electric with low water consumption. Where it may take over twenty gallons of water to clean a car with a hose, the present invention can clean a car with just two or three gallons.

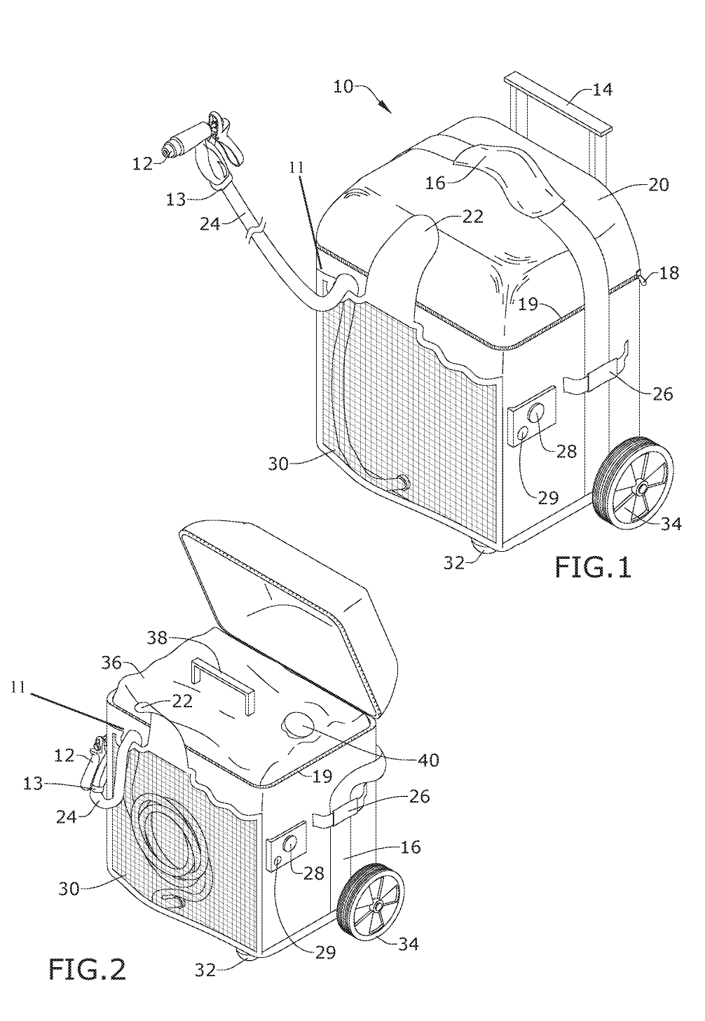

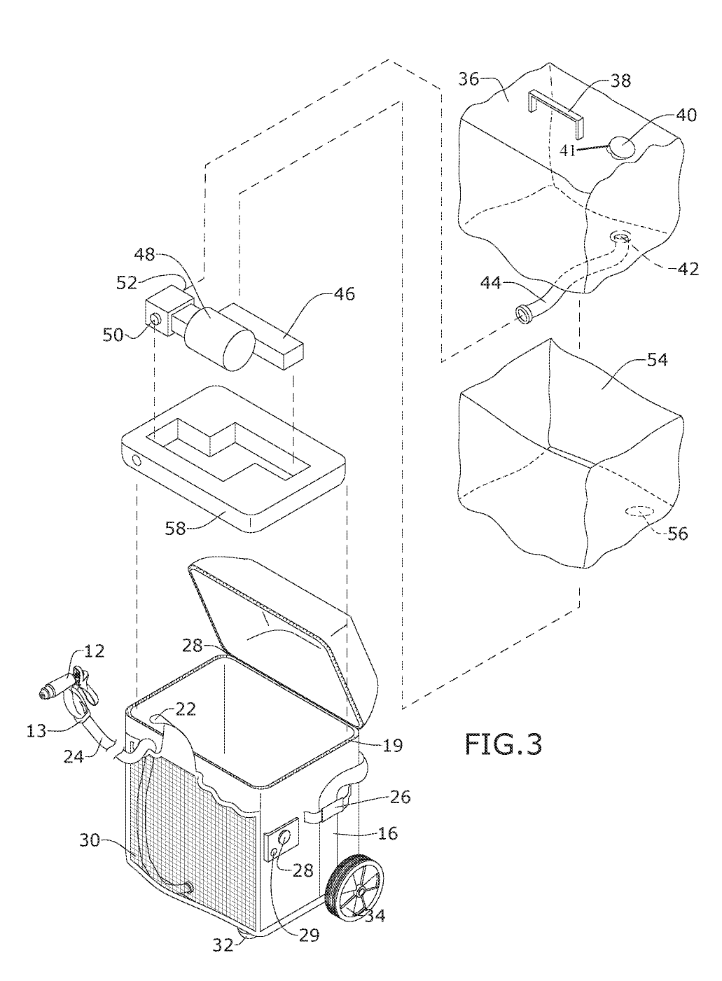

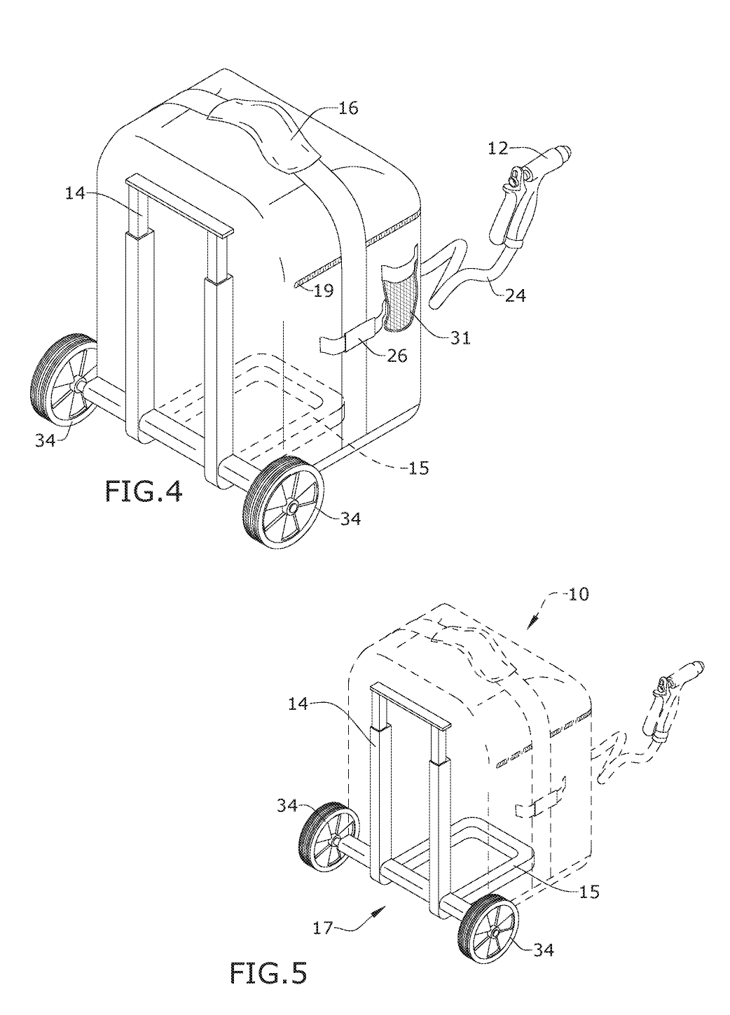

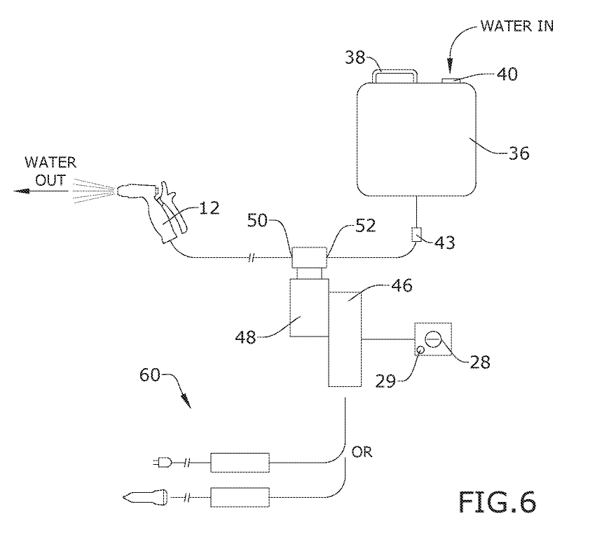

Referring to FIGS. 1 through 6, the present invention includes a portable power washer 10. The portable power washer 10 includes a housing 11. The housing 11 is made of a flexible material and includes a base, a sidewall, an opening, and a lid 20 openably and closably coupled the sidewall and covering the opening. A hose coupler 43 fluidly connects an inside of the housing 10 with an outside of the housing 10. A pump 48 is operable to pump a liquid from the inside of the housing 10 and through the hose coupler 43.

As mentioned above, the housing 11 is made of a flexible and compressible material, such as vinyl, rubber, NYLON™, or another woven or non-woven fabric. In certain embodiments, the housing 11 is made of an insulated material. The internal components may be removable from the housing 11, thereby turning the housing 11 into a cooler. In certain embodiments, feet 32 may be coupled to an outer surface of the base, supporting the housing 11 in an upright position. The housing 11 may further include side handles 26 and a shoulder strap 16 for carrying the housing 11.

The lid 20 may be attached to the housing 11 by a living hinge or fabric material, allowing the lid 20 to pivot towards and away from the housing 11. An upper edge of the sidewall may include a zipper track 19 and the lid 20 may include a zipper 18 that releasably closes the lid 20 to the housing 11. The housing 11 may further include a closure strap 22 with a hook and loop fastener for releasably attaching to the lid 20.

The present invention may further include a frame 17. The frame 17 includes a support 15, a pair of wheels 34 rotatably coupled to the support 15 and a retractable handle 14 upstanding from the support 15. The housing 11 is releasably coupled to the frame 17. The retractable handle 14 may be extended and the present invention may be rolled when transported via the wheels 34.

The housing 56 may further include a liner 54 with a hose opening 56. The liner 54 is removable and allows the user to open and service or replace the internal parts. Disposed within the liner 54 is a bag 36 made of a water impermeable material. The bag 36 includes an inlet opening 41, a cap 40 openably and closably coupled to the bag 36 and covering the inlet opening 41, an outlet opening 42, and a first hose 44 fluidly connected to the outlet opening 42 and fluidly connected to the hose coupler 43. The bag 36 may further include a handle 38 in order to grasp the bag 36 and remove the bag 36 from the housing 11. To fill the present invention with water, the lid 20 is opened, the cap is opened 40 and the user fills the bag 36 with water.

The present invention may further include a second hose 24 coupled to the hose coupler 43 and disposed substantially outside of the housing 11. A spray nozzle 12 is releasably secured to the second hose 24 by a quick connect 13. The present invention may detect when the spray nozzle 12 is not being used and automatically turn off the pump 48. A cleaning cartridge may be built into the spray nozzle 12 and may thereby contain a cleaning agent, which is dispensed when water is sprayed from the spray nozzle 12. The second hose 24 may be made of a rubber, silicone or the like and may be covered in a fabric, such as NYLON™. A pocket 30 is attached to the sidewall and is configured to stow the second hose 24 within when the present invention is not in use. The pocket 30 may be made of a mesh material, allowing the second hose 24 and spray nozzle 12 to air dry.

The pump 48 of the present invention is disposed within the housing 11. The pump 48 may provide multiple pressure spraying options. A dial or other control mechanism may be used to change the amount of pressure delivered by the pump 48. The pump 48 includes an inlet 52 and an outlet 50. The inlet 52 is coupled to the first hose 44 and the outlet is coupled to the hose coupler 43. Therefore, the pump 48 pumps water from the bag 36, through the first hose 44, into the second hose 24 and out of the spray nozzle 12. The present invention may further include a noise dampener 58. The noise dampener 58 may include a foam piece with a cutout portion. The noise dampener 58 is disposed within the housing 11 and the pump 48 is disposed within the cutout portion.

The present invention may include a battery 46 electrically connected to and powering the pump 48. The present invention may include one or more charge plugs 29 which are in electrical communication with the battery 46. The charge plug 29 is coupled to the sidewall and is outside of the housing 11. The charge plug 29 may include a universal serial bus (USB) or another type of power connection. The charge plug 29 may also allow the use of power from the battery 46 to charge other devices such as a lamp, fan, radio, air pump, a heater to heat water for showers, and more. The housing 11 may include a charging cord pocket 31 to contain the charger cord. To charge the battery 46, a charge cord may be connected to the charge plug 29 and plugged into a power source 60. Alternatively, a crank charge or a solar panel may be used to recharge the battery 46. A power button 28 is in communication with a switch electrically connecting the battery 46 and the pump 48. The power button 28 is also coupled to the sidewall and is outside of the housing 11. The present invention may further utilizer a two-way switch or a three way switch.

In use, the zipper 18 is unzipped and the lid 20 is pivoted to uncover the opening of the housing 11. The cap 40 is removed from inlet opening 41 of the bag 36 and the bag 36 is filled with water. The cap 40 is placed back onto the inlet opening 41. The lid 20 pivoted to cover the opening of the housing 11 and the zipper 18 is zipped back up. The button 28 may be pressed, turning the pump 48 on. The user may then grasp the spray nozzle 12 and apply pressure to the lever in order to spray water from the portable power washer 10. When not in use, the housing 11 may be removed from the frame 17. The housing 11 and the bag 36 may be emptied and compressed for storage.

It should be understood, of course, that the foregoing relates to exemplary embodiments of the invention and that modifications may be made without departing from the spirit and scope of the invention as set forth in the following claims.

What is claimed is:

1. A portable power washer comprising:
a housing made of a flexible material and comprising a base, a sidewall, an opening, and a lid openably and closably coupled the sidewall and covering the opening;
a hose coupler fluidly connecting an inside of the housing with an outside of the housing; and
a pump operable to pump a liquid from the inside of the housing and through the hose coupler.

2. The portable power washer of claim 1, further comprising a bag made of a water impermeable material, wherein the bag comprises an inlet opening, a cap openably and closably coupled to the bag and covering the inlet opening, an outlet opening, and a first hose fluidly connected to the outlet opening and fluidly connect to the hose coupler.

3. The portable power washer of claim 2, wherein the pump comprises an inlet and an outlet, wherein the inlet is coupled to the first hose and the outlet is coupled to the hose coupler.

4. The portable power washer of claim 2, further comprising a second hose coupled to the hose coupler and disposed outside of the housing.

5. The portable power washer of claim 4, further comprising a spray nozzle releasably secured to the second hose by a quick connect.

6. The portable power wash of claim 4, further comprising a pocket attached to the sidewall and configured to stow the second hose within.

7. The portable power washer of claim 1, further comprising a noise dampener comprising a foam piece with a cutout portion, wherein the noise dampener is disposed within the housing and the pump is disposed within the cutout portion.

8. The portable power washer of claim 1, further comprising a frame comprising a support, a pair of wheels rotatably coupled to the support and a retractable handle upstanding from the support, wherein the housing is coupled to the frame.

9. The portable power washer of claim 1, further comprising a power button in communication with a switch electrically connecting a battery and the pump, wherein the power button is coupled to the sidewall and is outside of the housing.

10. The portable power washer of claim 1, further comprising a shoulder strap coupled to the housing.
